(19) United States
(12) Patent Application Publication
(10) Pub. No.: US 2024/0275121 A1
(43) Pub. Date: Aug. 15, 2024

(54) SYSTEMS AND METHODS FOR WAVELENGTH DIVISION MULTIPLEXING

(71) Applicant: OFS Fitel LLC, Norcross, GA (US)

(72) Inventors: Andrew T Grimes, Morristown, NJ (US); Anand Hariharan, Franklin Park, NJ (US); Jeffrey W Nicholson, Warren, NJ (US)

(73) Assignee: OFS Fitel LLC, Norcross, GA (US)

(21) Appl. No.: 18/567,824

(22) PCT Filed: Jun. 9, 2022
(86) PCT No.: PCT/US22/32888

§ 371 Date: Dec. 7, 2023

Related U.S. Application Data
(60) Provisional application No. 63/209,321, filed on Jun. 10, 2021.

(51) Int. Cl. H01S 3/16; H01S 3/00; H01S 3/067; H01S 3/094; H01S 3/30; H04J 14/02

(52) U.S. Cl. CPC H01S 3/1608; H01S 3/0078; H01S 3/06754; H01S 3/094046; H01S 3/302; H04J 14/0221

(57) ABSTRACT

Embodiments of the present disclosure generally relate to systems, methods, and articles of manufacture for using a fiber laser with wavelength division multiplexers (WDMs) for a variety of purposes. For example, implementations described herein may be used with high-power Raman fiber laser (RFL) systems, or the like. A laser system is provided that may include a fiber laser; a laser path comprising optical fiber; and a plurality of wavelength division multiplexers (WDMs) positioned within the laser path coupling the optical fiber; wherein at least one of the plurality of WDMs has the widest wavelength spacing and is positioned first in the laser path, thereby providing increased power stability.

### CROSS-REFERENCE TO RELATED APPLICATIONS

The present application claims priority to U.S. Provisional Patent Application Ser. No. 63/209,321 entitled “Systems and Methods for Wavelength Division Multiplexing,” filed Jun. 10, 2021, the disclosure of which is incorporated herein by reference in its entirety.

### BACKGROUND

Described herein are systems, methods, and articles of manufacture for using wavelength division multiplexers (WDMs) and fiber lasers for a variety of purposes, such as high-power Raman fiber laser systems. A Raman fiber laser is optically pumped and may generally use stimulated Raman scattering as the light-amplification mechanism. Optical pumping is a process in which light is used as the power source to generate optical gain in a laser medium. Pump photons may be absorbed or scattered and re-emitted as lower-frequency laser-light photons called “Stokes” photons.

In general, WDMs take as an input two or more separate wavelengths propagating on different optical fibers and provide as an output both wavelengths propagating on a common fiber. WDMs may increase the number of signals transmitted through a single optical fiber, allowing for an increased capacity of an optical transmission device. WDMs may be used at the output of a Raman fiber laser for a few reasons. For example, WDMs may be used to filter the output and remove power at intermediary Stokes wavelengths (or out-of-band power). WDMs may also be used to combine the output with a signal source to be used in an optically pumped amplifier.

WDMs are characterized by the wavelengths that are designed to couple together in the WDM. For example, an erbium fiber amplifier with a pump wavelength at 1480 nm and signal wavelength at 1550 nm may require a WDM designed to couple together the wavelengths of 1480 nm and 1550 nm. When the design wavelengths of a WDM are narrowly spaced together, the design becomes more sensitive to design parameters such as taper ratio and taper length. Conversely, when the operating wavelengths are more widely spaced, then the design becomes less sensitive.

A Raman fiber laser may have a final output that is the result of either one or more Stokes shifts in a gain medium. The Raman shift is from a stimulated scattering. A Raman laser with multiple Stokes shifts is known as a Cascaded Raman fiber laser (CRFL). When the power in one Stokes grows high enough there may be enough gain at the next Stokes for stimulated scattering to begin. This process may lead to residual power at the wavelengths between the pump and the final wavelength. The power at wavelengths other than the desired final wavelength is known as out-of-band power, while the power at the final desired Stokes wavelength is known as in-band power.

For a high-power system, this may lead to several issues for WDMs. For example, out-of-band Stokes light may have significant power at the 1390 nm OH absorption. In addition, the overall power may couple to the cladding mode. This may cause a higher insertion loss for the WDM and coupling more power to where the cladding interfaces with the epoxy securing the fiber to a heatsink and submount. A submount may be a power-limiting component and may generally have the shortest lifespan of the components, because the WDM may include two fused tapers that combine to have the overall loss of one single fused taper. A single fused taper may have its loss minimized and controlled at the design wavelengths but not so at other wavelengths. When there is excess loss at the other wavelengths, these wavelengths may be dissipated in the cladding, where it will be absorbed by an epoxy that secures the fiber to its submount.

Efforts have been made to mitigate 1390 nm power using a tilted fiber Bragg grating, but these have proven insufficient for very high output powers. For example, when increasing the power above 100 Watts, WDMs may experience degradation in performance over time, particularly over one hundred hours.

### SUMMARY

Embodiments of the present disclosure generally relate to systems, methods, and articles of manufacture for using a fiber laser with wavelength division multiplexers (WDMs) for a variety of purposes. Embodiments of the present disclosure may include a laser system that may comprise a fiber laser; a laser path comprising optical fiber; and a plurality of wavelength division multiplexers (WDMs) positioned within the path of the laser in the optical fiber; wherein at least one of the plurality of WDMs has the widest wavelength spacing and is positioned first in the laser path, thereby providing increased power stability.

Embodiments of the present disclosure may also include a laser system comprising: a high-power Raman fiber laser (RFL); a laser path comprising optical fiber; a first wavelength division multiplexer (WDM) positioned within the laser path coupling the optical fiber, the first WDM positioned first in the laser path; and a second WDM positioned within the laser path coupling the optical fiber, the second WDM positioned after the wide WDM in the laser path; wherein the first WDM has a wider wavelength spacing than the second WDM and the first WDM is positioned first in the laser path, thereby providing increased power stability.

Embodiments of the present disclosure may also include a method of increasing power stability in a laser system, the method comprising: providing a Raman fiber laser; providing a plurality of wavelength division multiplexers (WDMs) positioned within a laser path, the laser path comprising optical fiber, wherein at least one of the plurality of WDMs has the widest wavelength spacing; positioning the at least one of the WDMs with the widest wavelength spacing first in the laser path, thereby providing increased power stability; and generating, by the Raman fiber laser, a laser through the laser path.

Embodiments of the present disclosure may also include a method of increasing power stability in a laser system, the method comprising: providing a Raman fiber laser; providing a plurality of wavelength division multiplexers (WDMs) positioned within a laser path, the laser path comprising optical fiber, wherein at least one of the plurality of WDMs has the widest wavelength spacing; positioning the at least one of the WDMs with the widest wavelength spacing first in the laser path, thereby providing increased power stability; and generating, by the Raman fiber laser, a laser through the laser path, and using the Raman laser as an optical pump source for another fiber amplifier, wherein the Raman laser pump source and signal source to be amplified are coupled together into the second gain medium by a WDM.

### BRIEF DESCRIPTION OF THE DRAWINGS

So the manner in which the above-recited features of the present disclosure can be understood in detail, a more particular description of embodiments of the present disclosure may be had by reference to the appended drawings. It is to be noted, however, the appended drawings illustrate only exemplary embodiments encompassed within the scope of the present disclosure and are not to be considered limiting, for the present disclosure may admit to other equally effective embodiments, wherein:

FIG. 1A is a chart illustrating a high-power Raman fiber laser (RFL) spectrum before tilted Bragg grating (TBG) filtering;

FIG. 1B is a chart illustrating a high-power RFL spectrum after TBG filtering;

FIG. 2 is a chart illustrating output power stability from a high power RFL with different output wavelength division multiplexers (WDMs);

FIG. 3 is a block diagram showing an example system using wavelength division WDMs in a high-power Raman fiber laser system in accordance with embodiments of the present disclosure;

FIG. 4 is a block diagram showing an example system using a Raman fiber laser as a pump source for an erbium fiber amplifier in accordance with embodiments of the present disclosure;

FIG. 5 is a chart illustrating a relationship between intensity and wavelength in a spectrum filtered by wide WDM, in accordance with embodiments of the present disclosure;

FIG. 6 is a chart illustrating normalized output power stability over time in a combination WDM, in accordance with embodiments of the present disclosure; and

FIG. 7 is a flow chart illustrating a method of using wavelength division WDMs in a high-power Raman fiber laser system in accordance with embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present disclosure generally relate to systems, methods, and articles of manufacture for using a fiber laser with wavelength division multiplexers (WDMs) for a variety of purposes. For example, implementations described herein may be used with high-power Raman fiber laser (RFL) systems, or the like. The example implementations described herein may solve or mitigate issues related to WDMs with narrow spacing between the wavelengths designed to couple together by lessening an overall amount of out-of-band power. Approaches and implementations consistent with the present disclosure may provide WDMs with wider spacing between design wavelengths, thereby increasing stability over time and removing or reducing out-of-band light present with WDMs with narrow spacing. As used herein, the terms “wide” and “narrow,” when used to describe a WDM, may be relative terms intended to indicate the WDM spacing is either “wider” or “narrower” than another WDM. The terms “wide” and “narrow” are not intended to limit the specific size of the WDM spacing individually without reference to other WDMs and are used for purposes of comparison with other WDMs present in the system, or the like.

In accordance with embodiments of the present disclosure, using a plurality of WDMs with different isolation wavelengths, staggered such that the widest-spaced design wavelengths are first in the system, the amount of filtering performed by individual WDMs may be distributed and reduced, while output power may be increased along with the lifespan of the system. In accordance with embodiments of the present disclosure, a WDM with wider spacing may be positioned before a WDM with narrower spacing in a laser system. This configuration may provide stable power and reduce irreversible degradation over long periods of time. In some examples, systems in accordance with the present disclosure may experience no irreversible degradation over long periods of time. For example, this implementation may provide stable power at levels in excess of 150 Watts and with no irreversible degradation for several hundred hours, or the like.

In accordance with exemplary embodiments of the present disclosure, a WDM may be, for example, a biconical fused fiber element that allows for the side coupling of fundamental modes in two fibers bonded (fused) together. Complete power transfer may occur after two cladding modes propagate through one half of a beat length in a coupling region, or the like. This coupling length may be determined as the length needed for the two design wavelengths to have a maximum transmission to one arm of the WDM while having the lowest transmission to another arm at the design wavelengths, or the like.

In accordance with exemplary embodiments of the present disclosure, when using similar fibers for the construction of a WDM, this coupling length may increase as the separation of the design wavelengths decreases. As the coupling length increases the WDM may then be subject to several detrimental effects. The longer the coupling length the more sensitive it may be to any change in length that may be causes due to heating, reducing in-band transmission. A longer coupling length may make the WDM more difficult to accurately build and target desired wavelengths. A longer coupling length may make a longer length of fiber exposed to a torch, increasing OH absorption, thereby causing issues with 1390 light, or the like.

A closer separation of the design wavelengths may result in a narrower transmission window of the design wavelength. In a broad wavelength source this can filter out additional in-band power. All these factors may lead to a reduced lifetime when used at high power where the degradation can cause a failure mechanism that can lead to a total system failure.

A narrow wavelength separation WDM may be beneficial if the application calls for combining two closely separated wavelengths. For example, narrow wavelength separation may be beneficial with an erbium amplifier where the pump light at 1480 nm from a Raman laser will be combined with the seed source light which may be between 1545-1600 nm, or the like. Additionally, narrow wavelength separation may be beneficial in single frequency Raman amplifiers, where the pump may be one Stokes shift below the signal/seed wavelength, or the like. Also, narrow wavelength separation may be beneficial in an amplifier configuration at Yb wavelengths. In another example, narrow wavelength separation may be beneficial to isolate a primary laser output from Stokes generated in a delivery fiber, or the like.

In accordance with exemplary embodiments of the present disclosure, to account for the narrow wavelength separation WDM issues, a WDM with design wavelengths that may be further spaced, may be used as an initial filtering element prior to a narrow wavelength separation WDM. The broader WDM may have a shorter coupling length and broader filtering. These broader WDMs may show virtually no degradation in performance over thousands of hours at high power, or the like.

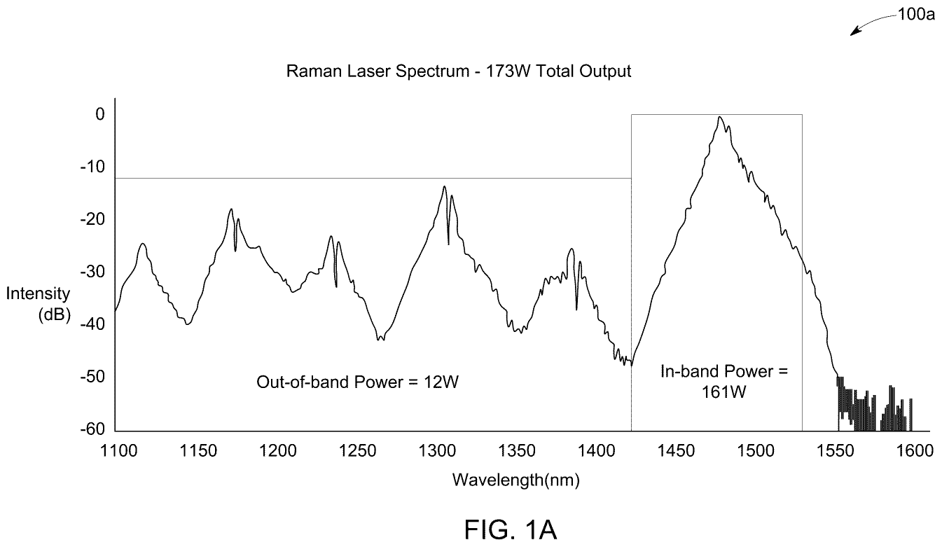

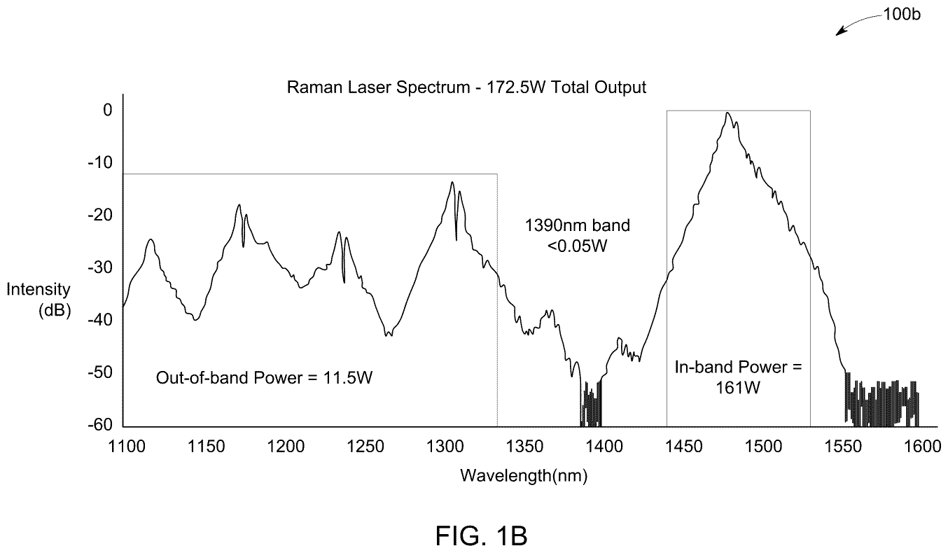

FIG. 1A is a chart 100a illustrating a high-power Raman fiber laser (RFL) spectrum before tilted Bragg grating (TBG) filtering. In this example, out-of-band power is approximately 12 W and in-band power is approximately 161 W. The total output of the Raman laser spectrum in this example is approximately 173 W. FIG. 1B is a chart 100b illustrating a high-power RFL spectrum after TBG filtering. In this example, out-of-band power is approximately 11.5 W, the 1390 nm band is less than approximately 0.05 W, and in-band power is approximately 161 W. The total output of the Raman laser spectrum in this example is approximately 172.5 W.

In accordance with some implementations, an RFL may be a laser whose output is the resultant of one or more Raman Stokes shifts. The RFL may enable shifting of a fixed wavelength laser, which may be a rare-earth doped fiber, to a wavelength needed for a specific application. Raman shifts may generally be an efficient process leading to high output spectral purity at the desired wavelength in excess, for example, of 90% with the rest of the power at the pump and intermediary Stokes wavelengths. Increasing the overall output power may also increase the amount of residual power at these wavelengths to a point where system stability and performance may be compromised.

Fused fiber WDMs may be used in fiber laser for a variety of purposes. For example, in some fiber laser systems, a high-power erbium amplifier pumped by a 1480 nm Raman laser, or the like, may use a fused fiber WDM to couple pump and signal together and launch into the erbium fiber. After exposure to high power Raman fiber laser output, the fused-fiber WDM may degrade in performance over time. In some cases, there may be an overtone for the OH molecular absorption that overlaps with 1390 nm light generated by the Raman fiber laser. To solve this issue, in some implementations, specialized fiber filters adapted and designed to reject this 1390 nm power from the output before entering any other system components may be used.

In some implementations, system output may be able to remain stable over time using this filtering technique. For example, system output may remain stable for over one-thousand hours with the output power up to 100 Watts. At output power levels above 100 Watts, however, the system output may begin to degrade irreversibly over time. For example, the system output may degrade after approximately 100 hours and increasing the filtering of the 1390 nm component may have limited or no effect on increasing the time until this degradation occurs. In accordance with embodiments of the present disclosure, design wavelength separation of the WDM itself may determine or affect the overall stability and duration until output power begins to irreversibly degrade.

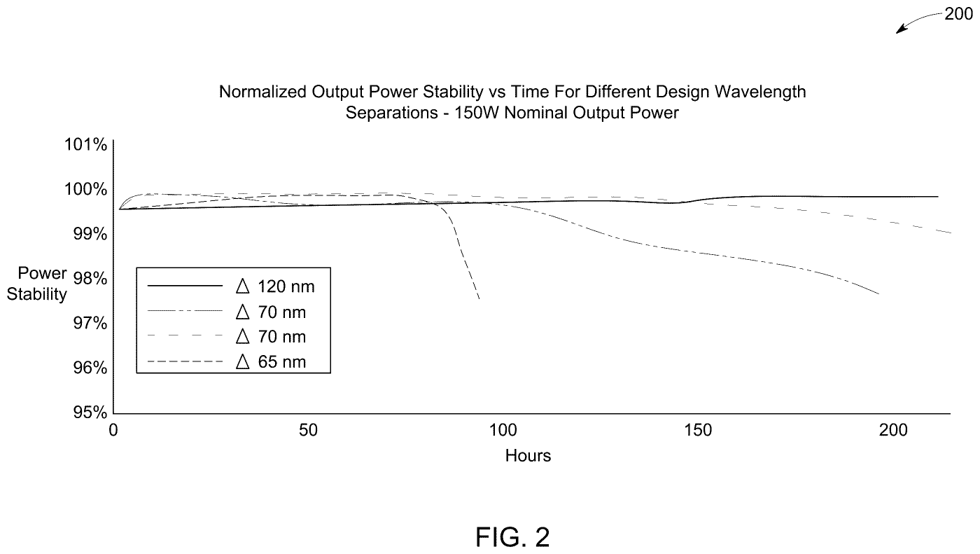

FIG. 2 is a chart 200 illustrating output power stability from a high power RFL with different output WDMs. The chart 200 demonstrates normalized output stability over time for different design wavelength separations and 150 W nominal output power. As shown in the chart 200, when using similar fibers for the construction of a WDM, broadening the design wavelength separation results in a significant increase in the length of time the Raman fiber laser can operate without showing significant power degradation. The coupling length where the fibers are fused together increases as the separation of the design wavelengths decreases. As the coupling length increases, the WDM may then be subject to several effects. For example, the longer the coupling length, the more sensitive it is to any change in length that may be caused by heating. This may reduce in-band transmission. A longer coupling length may make the WDM more difficult to accurately build and target desired wavelengths. A longer coupling length may make a longer length of fiber exposed to a torch, increasing OH absorption and making absorption of 1390 nm light an issue. Therefore, the length of time that the Raman laser can operate is inversely correlated with the coupling length in the WDM.

Closer separation of the design wavelengths may result in a narrower transmission window of the design wavelength. For example, in a broad wavelength source, this may filter out some additional in-band power. A longer coupling length may have more properties similar to a biconical fiber taper made out of a single fiber where out-of-band components will have higher insertion losses and will couple more into the cladding mode, where their power will be absorbed by the epoxy, creating a localized heating effect that may harm the overall transmission and can lead to an irreversible runaway effect, or the like. A flame may be less even when it is traversing the longer fuse length, making it less symmetrical and causing additional insertion loss at the non-specified design wavelengths.

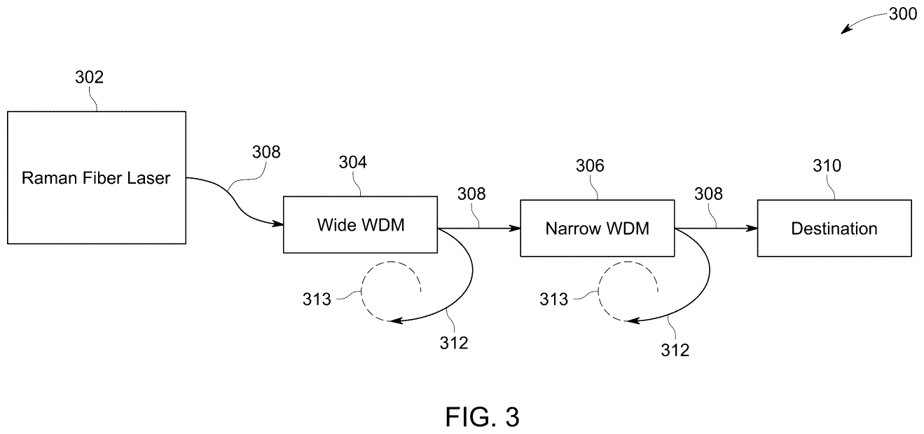

FIG. 3 is a block diagram showing an example system 300 using WDMs in a laser system, such as a high-power RFL system, in accordance with embodiments of the present disclosure. In accordance with some implementations of the present disclosure, a system 300 may comprise an RFL 302, an optical fiber 308, a plurality of WDMs 304, 306, a laser destination 310, additional optical fiber 312, or the like. Although an RFL 302 is shown in FIG. 3, this is for exemplary purposes and other types of lasers consistent with the present disclosure may be used. In some implementations, a plurality of WDMs may comprise a wide WDM 404, and a narrow WDM 306, or other combinations of wider and narrower WDMs, or the like. Although two WDMs 304, 306 are depicted, it is contemplated that additional WDMs may be included in a system 300 in accordance with the present disclosure. In some implementations, an optical fiber 308 may be communicatively coupled with WDMs 304, 306 to form a laser path between the laser 302 and a destination 310. In some embodiments, the system 300 may include additional optical fiber 312 for coupling with additional destinations, or the like. The system 300 may also include, for example, a coreless fiber 313 for end-terminating the optical fiber, or the like.

In accordance with exemplary embodiments, many issues related to the use of a narrow spaced WDM 306, including those mentioned above, may be lessened or mitigated if the overall amount of out of band power is lessened as well. A wide WDM 304 (i.e., a WDM with wider spacing) may be stable for hundreds of hours and may remove the out-of-band light that is an issue for a narrow WDM 306 (i.e., a WDM with narrower spacing), or the like. In some implementations, a configuration where a wider-spaced or wide WDM 304 is positioned before a narrower-spaced or narrow WDM 306 along a laser path between a laser 302 and a destination 310 may provide stable power. For example, a wide WDM before a narrow WDM may provide stable power at levels in excess of 150 Watts with no irreversible degradation over many hours. In some implementations, systems in accordance with the present disclosure may show no irreversible degradation over several hundred hours.

In accordance with exemplary embodiments of the present disclosure, a filtering and beam combining mechanism may allow for higher power operation of narrow-spaced or narrow WDMs 306. Filtering may be performed in a staggered manner with multiple WDMs, where the transmission design wavelengths for each WDM may be the same, but the isolation design wavelengths for each WDM do not overlap. For example, 1480/1600 and 1480/1550 may be implemented as the design wavelengths of two separate WDMs 304, 306. In some implementations, a first wide WDM 304 design wavelengths may be spaced further than any subsequent narrow WDM 306. Implementation of configurations consistent with the present disclosure allows a first wide WDM 304 to be less susceptible to issues like power degradation or drift. In some implementations, a first wide WDM 304 may have a shorter coupling length than any subsequent narrow WDM 306.

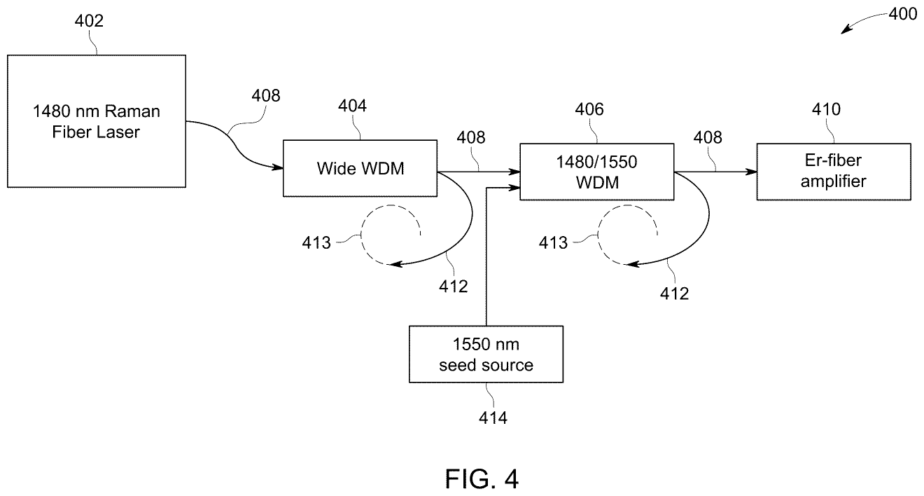

FIG. 4 is a block diagram showing an example system 400 using a Raman fiber laser (RFL) 402 as a pump source for an erbium fiber amplifier 410 in accordance with embodiments of the present disclosure. The system 400 may include a seed source 414. The seed source may comprise, for example, a 1550 nm seed laser, or the like. The Raman fiber laser 402, may comprise, for example, a 1480 nm Raman fiber laser pumping an erbium fiber amplifier 410. It is contemplated by and within embodiments of the present disclosure that although an erbium fiber amplifier is illustrated in FIG. 4, a Raman fiber laser can generally be used to pump other fiber amplifiers as well. For example, a Raman fiber laser may be used to pump fiber amplifiers such as thulium-doped fiber amplifiers, bismuth-doped fiber amplifiers, or Raman fiber amplifiers, or the like.

In accordance with some implementations of the present disclosure, the system 400 may comprise an RFL 402, an optical fiber 408, a plurality of WDMs 404, 406, a laser destination 410, additional optical fiber 412, or the like. Although an RFL 402 is shown in FIG. 4, this is for exemplary purposes and other types of lasers consistent with the present disclosure may be used. In some implementations, a plurality of WDMs may comprise a first WDM 404 having the widest spacing, and a second WDM 406 having narrower spacing, or other combinations of wider and narrower WDMs, or the like. Although two WDMs. 404, 406 are depicted, it is contemplated that additional WDMs may be included in a system 400 in accordance with the present disclosure. In some implementations, an optical fiber 408 may be communicatively coupled with WDMs 404, 406 to form a laser path between the laser 402 and a destination 410. In some embodiments, the system 400 may include additional optical fiber 412 for coupling with additional destinations, or the like. The system 400 may also comprise, for example, a coreless fiber 413 for end-terminating the optical fiber, or the like.

In some implementations, a configuration where the first, wider-spaced WDM 404 is positioned before a second, narrower-spaced WDM 406 along a laser path between a laser 402 and an erbium fiber amplifier 410 may provide stable power. For example, a wide WDM before a narrow WDM may provide stable power at levels in excess of 150 Watts with no irreversible degradation over many hours. In some implementations, systems in accordance with the present disclosure may show no irreversible degradation over several hundred hours.

In accordance with exemplary embodiments of the present disclosure, the system 400 may comprise an erbium fiber amplifier 410, a seed source 414, a second WDM 406 of a plurality of the WDMs, the second WDM 406 for coupling the fiber laser 402 and the seed source 414 with the erbium fiber amplifier 410. In some implementations, the seed source 414 may be a 1550 nm seed laser, or the like. The second WDM 406 may comprise a longer coupling length and broader filtering than the first WDM 404 with the widest wavelength spacing. In some implementations, the fiber laser 402 may comprise a 1480 nm Raman fiber laser. In some examples, the transmission design wavelengths of each of the of WDMs 404, 406 may be the same and isolation design wavelengths for each of the WDMs 404, 406 may be different and may not overlap.

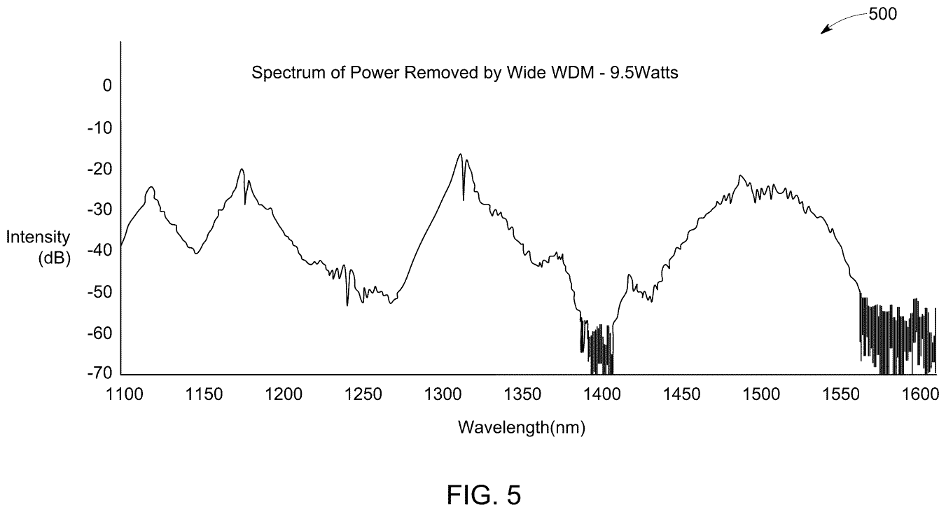

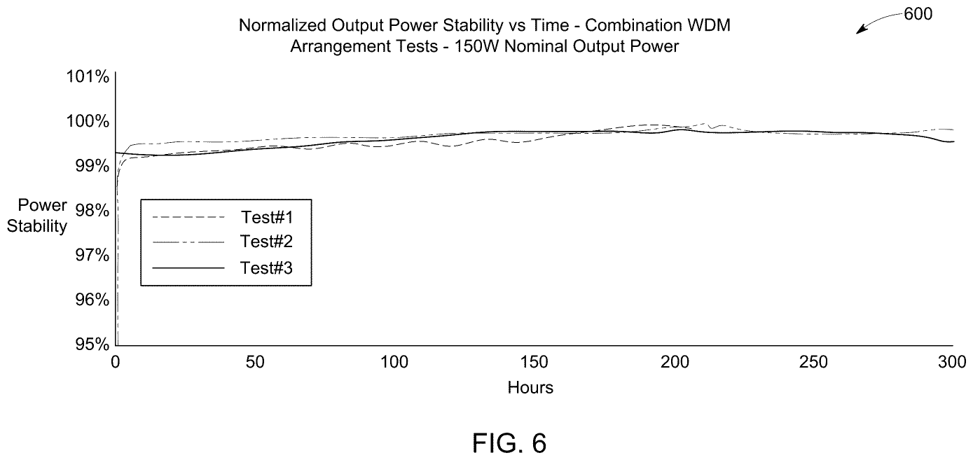

FIG. 5 is a chart 500 illustrating a relationship between intensity and wavelength in a spectrum filtered by wide WDM, in accordance with embodiments of the present disclosure. The chart 500 shown in FIG. 5 demonstrates the relationship between intensity and wavelength and demonstrates a spectrum of power removed by a wide WDM at approximately 9.5 Watts, or the like. FIG. 6 is a chart 600 illustrating normalized output power stability over time in a combination WDM, in accordance with embodiments of the present disclosure. The chart 600 shown in FIG. 6 demonstrates normalized output power stability over time in combination wide and narrow WDM arrangement with 150 W nominal output power.

In some applications that are not overly wavelength sensitive, WDMs with wide wavelength spacing may be used in high power Raman fiber laser systems. However, in some applications, such as an erbium amplifier pumped by a Raman laser, or the like, specific WDMs with narrow wavelength spacing may be beneficial. WDMs with 1480 nm and 1550 nm operating wavelength are common in such systems. In these examples, by using multiple WDMs with different isolation wavelengths, staggered in such a way that the widest spaced design wavelengths are first, we are able to distribute and reduce the amount of filtering performed by individual WDM and increase the output power as well as the lifespan of the system.

The broader WDM may have a shorter coupling length and broader filtering. These broader WDMs show virtually no degradation in performance over 1000's of hours at high powers. A narrow wavelength separation WDM may be beneficial if the application calls for combining two closely separated wavelengths. For example, narrow wavelength separation may be beneficial with an erbium amplifier where the pump light at 1480 nm from a Raman laser will be combined with the seed source light which is typically between 1545-1600 nm, or the like. Additionally, narrow wavelength separation may be beneficial in single frequency Raman amplifiers, where the pump may be one Stokes shift below the signal/seed wavelength, or the like. Also, narrow wavelength separation may be beneficial in an amplifier configuration at Yb wavelengths. In another example, narrow wavelength separation may be beneficial to isolate a primary laser output from Stokes generated in a delivery fiber, or the like.

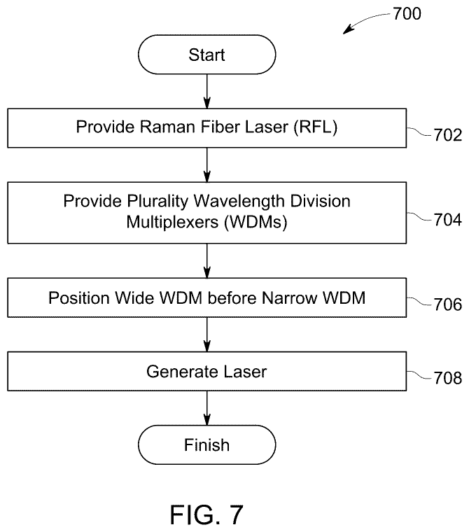

FIG. 7 is a flow chart illustrating a method 700 of using WDMs in a high-power Raman fiber laser system in accordance with embodiments of the present disclosure. The method 700 may begin and at 702, a RFL may be provided. For example, a RFL may comprise a high-power RFL. The method may continue at 704, where a plurality of WDMs may be provided. In accordance with some embodiments, the WDMs may comprise a wide WDM and a narrow WDM, or the like. In accordance with exemplary embodiments the wide WDM may comprise a shorter coupling length than any subsequent WDM of the plurality of WDMs within the laser path.

The method 700 may continue at 706, where the WDMs are positioned within the system. In example implementations, the widest WDM may be positioned before narrower WDM in the system. For example, in an example with two WDMs, a wide WDM may be positioned before a narrow WDM in the system. The method 700 continues and at 708, a laser is generated. The laser may pass through the wide WDM and narrow WDM before reaching its destination, or the like. This configuration may provide stable power and reduce irreversible degradation over long periods of time. For example, this implementation may provide stable power at levels in excess of 150 Watts and with no irreversible degradation for several hundred hours, or the like.

For the purpose of simplification and clarity of illustration, a general configuration scheme is illustrated in the accompanying drawings, and a detailed description for the features and the technology well-known in the art is omitted in order to prevent the discussion of exemplary embodiments of the present disclosure from being unnecessarily obscure. Additionally, components in the accompanying drawings are not necessarily drawn to scale. For example, sizes may be exaggerated in order to assist in the understanding of exemplary embodiments of the present disclosure.

It will be understood that exemplary embodiments of the present disclosure set forth herein may be operated in a sequence different from a sequence illustrated or described herein. In the case in which it is described herein that a method includes a series of steps, a sequence of these steps suggested herein is not necessarily a sequence in which these steps may be executed.

Terms used in the present disclosure are for explaining exemplary embodiments rather than limiting the present disclosure. In the present disclosure, a singular form includes a plural form unless explicitly described to the contrary. Components, steps, operations, and/or elements mentioned by terms “comprise” and/or “comprising” used in the disclosure do not exclude the existence or addition of one or more other components, steps, operations, and/or elements.

Hereinabove, the present disclosure has been described with reference to exemplary embodiments thereof. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure. Although numerous embodiments having various features have been described herein, combinations of such various features in other combinations not discussed herein are contemplated within the scope of embodiments of the present disclosure.

What is claimed is:

1. A laser system comprising:
a fiber laser;
a laser path comprising optical fiber; and
a plurality of wavelength division multiplexers (WDMs) positioned within the laser path coupling the optical fiber;
wherein at least one of the plurality of WDMs has the widest wavelength spacing and is positioned first in the laser path, thereby providing increased power stability.

2. The laser system of claim 1, further comprising:
a fiber amplifier;
a seed source;
a second WDM of the plurality of the WDMs, the second WDM for coupling the fiber laser and the seed source with the fiber amplifier.

3. The laser system of claim 2, wherein the fiber amplifier comprises an Erbium fiber amplifier.

4. The laser system of claim 2, wherein the seed source is a 1550 nm seed laser.

5. The laser system of claim 2, wherein the second WDM comprises a longer coupling length and broader filtering than the at least one of the plurality of WDMs with the widest wavelength spacing.

6. The laser system of claim 1, wherein the fiber laser is a pump source for a fiber amplifier.

7. The laser system of claim 1, wherein the fiber laser comprises a 1480 nm Raman fiber laser.

8. The laser system of claim 1, wherein transmission design wavelengths of each of the plurality of WDMs are the same; and
wherein isolation design wavelengths for each of the plurality of WDMs are different and do not overlap.

9. A laser system comprising:
a high-power Raman fiber laser (RFL);
a laser path comprising optical fiber;
a first wavelength division multiplexer (WDM) positioned within the laser path coupling the optical fiber, the first WDM positioned first in the laser path; and
a second WDM positioned within the laser path coupling the optical fiber, the second WDM positioned after the wide WDM in the laser path;
wherein the first WDM has a wider wavelength spacing than the second WDM and the first WDM is positioned first in the laser path, thereby providing increased power stability.

10. The laser system of claim 9, further comprising:
a fiber amplifier;
a seed source; and
wherein the second WDM couples the fiber laser and the seed source with the fiber amplifier.

11. The laser system of claim 10, wherein the fiber amplifier comprises an erbium fiber amplifier.

12. The laser system of claim 10, wherein the seed source is a 1550 nm seed laser.

13. The laser system of claim 9, wherein the fiber laser comprises a 1480 nm Raman fiber laser; and
the fiber laser comprises a pump source for an erbium fiber amplifier.

14. A method of increasing power stability in a laser system, the method comprising:
providing a Raman fiber laser;
providing a plurality of wavelength division multiplexers (WDMs) positioned within a laser path, the laser path comprising optical fiber, wherein at least one of the plurality of WDMs has the widest wavelength spacing;
positioning the at least one of the WDMs with the widest wavelength spacing first in the laser path, thereby providing increased power stability; and
generating, by the Raman fiber laser, a laser through the laser path.

15. The method of claim 14, further comprising:
providing an erbium fiber amplifier;
providing a seed source;
providing a second WDM of the plurality of the WDMs, the second WDM for coupling the fiber laser and the seed source with the erbium fiber amplifier.

16. The method of claim 15, wherein the seed source is a 1550 nm seed laser.

17. The method of claim 15, wherein the second WDM comprises a longer coupling length and broader filtering than the at least one of the plurality of WDMs with the widest wavelength spacing.

18. The method of claim 14, wherein the fiber laser is a pump source for an erbium fiber amplifier.

19. The method of claim 14, wherein the fiber laser comprises a 1480 nm Raman fiber laser.

20. The method of claim 14, wherein isolation design wavelengths for each of the plurality of WDMs are different and do not overlap.
